(19) United States
(12) Patent Application Publication
(10) Pub. No.: US 2016/0250887 A1
(43) Pub. Date: Sep. 1, 2016

(54) HYGIENE SYSTEM FOR DISPLAYING A DISPLAY MEDIUM

(71) Applicant: GOJO Industries, Inc., Akron, OH (US)

(72) Inventors: Matthew Joseph Archer, Aurora, OH (US); Joey Suntken, Hudson, OH (US); John Timmons, Aurora, OH (US)

(21) Appl. No.: 15/055,862

(22) Filed: Feb. 29, 2016

Related U.S. Application Data
(60) Provisional application No. 62/121,733, filed on Feb. 27, 2015.

(51) Int. Cl. B43L 1/10; B43L 1/00; A47K 5/12

(52) U.S. Cl. CPC B43L 1/10; A47K 5/12; B43L 1/00

(57) ABSTRACT

A hygiene system for dispensing a hygiene product includes a hygiene system housing. The hygiene system housing has a mounting portion and a surface portion attached to the mounting portion. The mounting portion is mounted to a mounting surface. The hygiene system includes a dispensing mechanism disposed within an interior of the hygiene system housing between the mounting portion and the surface portion. The dispensing mechanism is used to dispense the hygiene product. The hygiene system includes a display structure attached to the surface portion. The display structure supports a display medium disposed between an outer surface of the surface portion and an inner surface of the display structure. The display structure is substantially transparent such that the display medium is visible through the display structure.

### CROSS-REFERENCE TO RELATED APPLICATIONS

This application claims priority to U.S. Provisional Application No. 62/121,733, titled “HYGIENE SYSTEM FOR DISPLAYING A DISPLAY MEDIUM” and filed on Feb. 27, 2015, the entire disclosure of which is hereby incorporated by reference.

### TECHNICAL FIELD

The instant application is directed towards a hygiene system. For example, the instant application is directed towards a hygiene system for displaying a display medium.

### BACKGROUND

Hygiene systems can dispense a hygiene product to a user. Hygiene systems can be used, for example, in schools, hospitals, nursing homes, factories, restaurants, etc.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

In an example, a hygiene system for dispensing a hygiene product comprises a hygiene system housing comprising a mounting portion and a surface portion attached to the mounting portion. The mounting portion is configured to be mounted to a mounting surface. The hygiene system comprises a dispensing mechanism disposed within an interior of the hygiene system housing between the mounting portion and the surface portion. The dispensing mechanism is configured to dispense the hygiene product. The hygiene system comprises a display structure attached to the surface portion and configured to support a display medium disposed between an outer surface of the surface portion and an inner surface of the display structure. The display structure is substantially transparent such that the display medium is visible through the display structure

In another example, a hygiene system for dispensing a hygiene product comprises a hygiene system housing comprising a mounting portion and a display structure. The mounting portion is configured to be mounted to a mounting surface. The hygiene system comprises a dispensing mechanism disposed within an interior of the hygiene system housing between the mounting portion and the display structure. The dispensing mechanism is configured to dispense the hygiene product. The display structure is moveably attached to the mounting portion. The display structure is moveable between an opened position in which the dispensing mechanism is exposed, and a closed position in which the dispensing mechanism is not exposed. The display structure defines a display space between an inner surface of the display structure and an outer surface of the dispensing mechanism when in the closed position. The display structure is configured to support a display medium disposed within the display space. The display structure is substantially transparent such that the display medium is visible through the display structure.

In another example, a hygiene system for dispensing a hygiene product comprises a hygiene system housing comprising a mounting portion and a display structure attached to the mounting portion. The mounting portion is configured to be mounted to a mounting surface. The hygiene system comprises a dispensing mechanism disposed within an interior of the hygiene system housing between the mounting portion and the display structure. The dispensing mechanism is configured to dispense the hygiene product. The display structure comprises at least one of a dry-erase board or a chalkboard.

The following description and annexed drawings set forth certain illustrative aspects and implementations. These are indicative of but a few of the various ways in which one or more aspects can be employed. Other aspects, advantages, and/or novel features of the disclosure will become apparent from the following detailed description when considered in conjunction with the annexed drawings.

### DESCRIPTION OF THE DRAWINGS

FIG. 1 is an illustration of a first example hygiene system;

FIG. 2 is an illustration of a first example hygiene system;

FIG. 3 is an illustration of a first example hygiene system;

FIG. 4 is an illustration of a first example hygiene system;

FIG. 5A is an illustration of a first example hygiene system;

FIG. 5B is an illustration of a first example hygiene system;

FIG. 6 is an illustration of a second example hygiene system;

FIG. 7 is an illustration of a second example hygiene system;

FIG. 8 is an illustration of a second example hygiene system;

FIG. 9 is an illustration of a third example hygiene system;

FIG. 10 is an illustration of a third example hygiene system; and

FIG. 11 is an illustration of a third example hygiene system.

### DETAILED DESCRIPTION

The claimed subject matter is now described with reference to the drawings, wherein like reference numerals are used to refer to like elements throughout. In the following description, for purposes of explanation, numerous specific details are set forth in order to provide an understanding of the claimed subject matter. It is evident, however, that the claimed subject matter can be practiced without these specific details. In other instances, structures and devices are illustrated in block diagram form in order to facilitate describing the claimed subject matter. Relative size, orientation, etc. of parts, components, etc. may differ from that which is illustrated while not falling outside of the scope of the claimed subject matter.

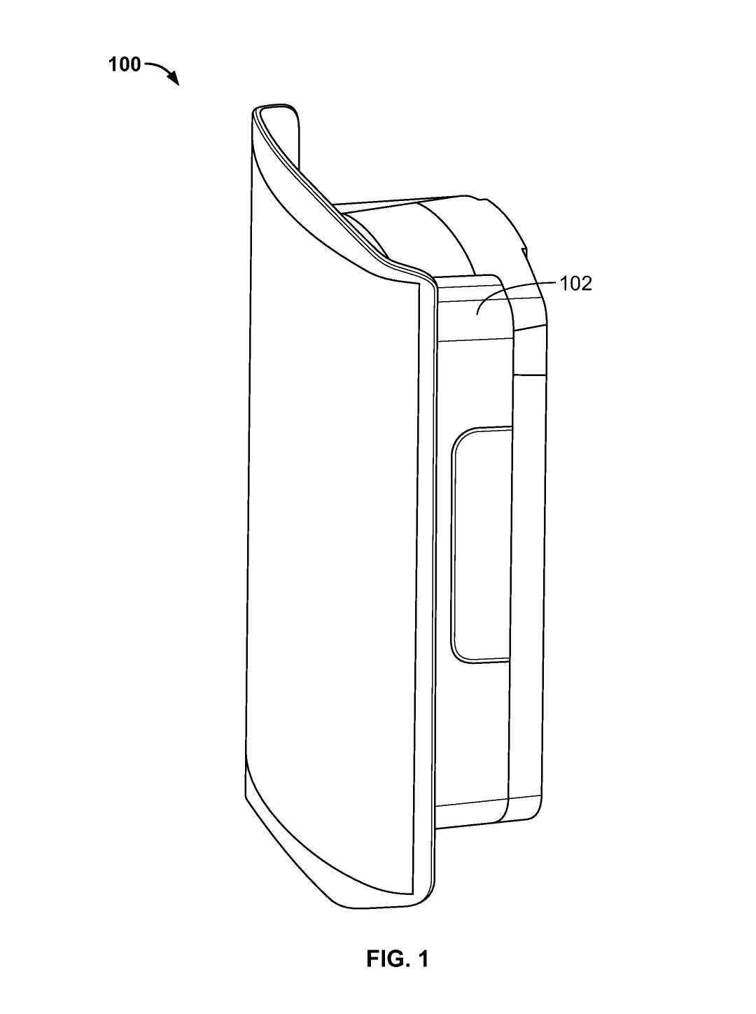

Referring to FIG. 1, an example hygiene system 100 is illustrated. The hygiene system 100 can be used for storing and/or dispensing a hygiene product. The hygiene system 100 can be attached, for example, to a mounting surface, such as a surface of a wall, ceiling, door, object, support structure, etc. The hygiene system 100 can be used in environments such as prisons, jails, detention centers, mental health facilities, hospital, rehabilitation facilities, nursing homes, restaurants, schools, factories, warehouses, etc.

In an example, the hygiene system 100 comprises a hygiene system housing 102. The hygiene system housing 102 comprises a reservoir, enclosure, etc. within which portions of the hygiene system 100 may be housed. In some examples, the hygiene system housing 102 is substantially hollow so as to receive structures, components, etc. therein. In the illustrated example, the hygiene system housing 102 comprises a rigid and/or durable structure or material, such as a plastic material, a metal material, or the like. In some examples, the hygiene system housing 102 comprises one or more openings and/or doors to allow for access to an interior of the hygiene system housing 102.

Turning to FIG. 2, an interior 200 of the hygiene system housing 102 is illustrated. The hygiene system housing 102 comprises a mounting portion 202 and a surface portion 204 that is attached to the mounting portion 202. In an example, the mounting portion 202 can be mounted to a mounting surface 203 (e.g., a surface of a wall, ceiling, door, object, support structure, etc.). The mounting portion 202 comprises a wall, a barrier, a partition, etc. that separates the interior 200 and an exterior of the hygiene system housing 102. In an example, the mounting portion 202 defines an inner side 206 and an outer side 208. The inner side 206 can face the interior 200 of the hygiene system housing 102. The outer side 208 can face the mounting surface 203, such as by being in contact with and/or mounted to the mounting surface 203. In some examples, the mounting portion 202 defines one or more openings, holes, channels, etc. through which fasteners can extend so as to attach the hygiene system housing 102 to the mounting surface.

The surface portion 204 of the hygiene system housing 102 can be removably attached to the mounting portion 202. In this example, an attachment portion 205 of the surface portion 204 can be attached to the mounting portion 202. In this example, the attachment portion 205 has a cross-sectional size that substantially matches a cross-sectional size (e.g., height, width, etc.) of the mounting portion 202. In an example, one or more mechanical fasteners can be provided as part of the mounting portion 202 and/or the surface portion 204 so as to attach the mounting portion 202 and the surface portion 204. In some examples, these mechanical fasteners may comprise locking structures (e.g., snap fit structures), screws, bolts, nuts, etc.

The mounting portion 202 and the surface portion 204 can together define the interior 200 of the hygiene system housing 102. The interior 200 of the hygiene system housing 102 is substantially hollow so as to receive the structures, components, etc. of the hygiene system 100.

The hygiene system 100 comprises a reservoir 220. The reservoir 220 comprises a container, enclosure, vessel, pouch, etc. into which a hygiene product 222 can be received and from which the hygiene product 222 can be dispensed. The reservoir 220 can be supported within the interior 200 of the hygiene system housing 102, such as between the mounting portion 202 and the surface portion 204. In some examples, the hygiene product 222 that is contained within the reservoir 220 comprises soaps, cleaners, disinfectants, sanitizers, antiseptics, moisturizers, alcohol-infused liquids, or the like. In other examples, the hygiene product 222 comprises liquid or semi-liquid materials.

The hygiene system 100 comprises a dispensing mechanism 224 for dispensing the hygiene product 222 from the reservoir 220. The dispensing mechanism 224 can be disposed within the interior 200 of the hygiene system housing 102 between the mounting portion 202 and the surface portion 204. In this example, the dispensing mechanism 224 can be located within a lower portion of the interior 200, such as below the reservoir 220.

The dispensing mechanism 224 can be operatively coupled to the reservoir 220. That is, by being operatively coupled, the dispensing mechanism 224 can be in fluid communication with an opening in the reservoir 220 so as to selectively dispense the hygiene product 222 (e.g., during a dispense event) from the reservoir 220. A dispense event may be actuated by the dispensing mechanism 224 such that the hygiene product 222 is dispensed from the reservoir 220. In some examples, the dispensing mechanism 224 comprises one or more of a pump, an actuator, sensors, levers, or other types of devices that can assist in causing an expulsion of the hygiene product 222 from the reservoir 220. The hygiene system housing 102 defines an opening 226 in proximity to the dispensing mechanism 224 through which the hygiene product 222 can be expelled from the hygiene system housing 102. In an example, the opening 226 is defined within the surface portion 204 and/or the mounting portion 202. The opening 226 in this example is located below the dispensing mechanism 224 and below the reservoir 220.

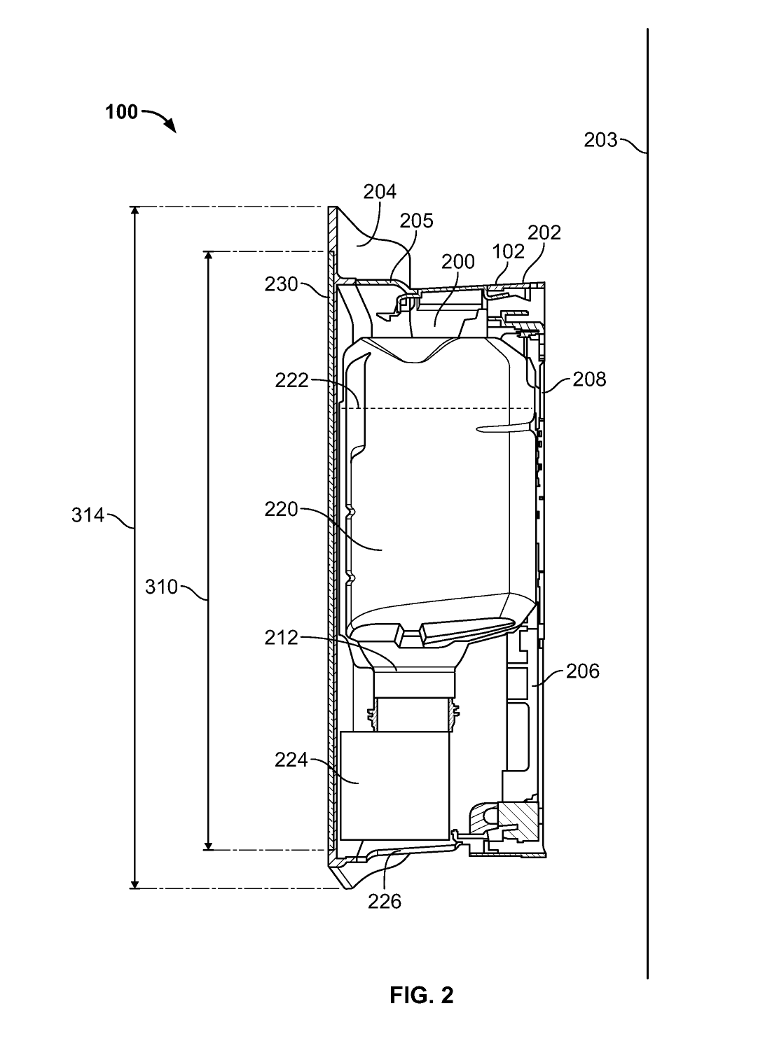

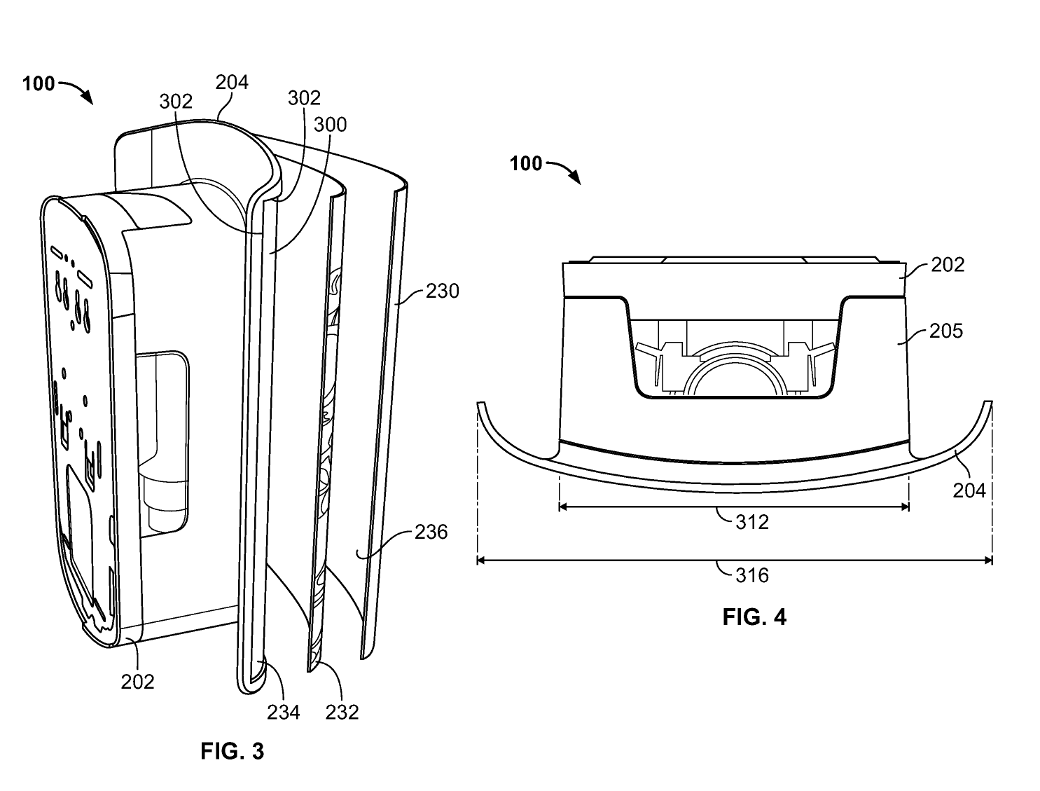

Referring now to FIGS. 2 and 3, the hygiene system 100 comprises a display structure 230 that can be removably attached to the surface portion 204. In an example, the display structure 230 can be attached to the surface portion 204 to support a display medium 232 between an outer surface 234 of the surface portion 204 and an inner surface 236 of the display structure 230. The display structure 230 can, in some examples, be substantially transparent such that the display medium 232 is visible through the display structure 230. For example, the display structure 230 can comprise a number of different transparent structures, such as a viewfoil (e.g., a transparent film), a rigid and/or a semi-rigid transparent cover, or the like. The display structure 230 comprises, for example, glass, plastic, or the like.

The display medium 232 can display textual and/or graphic elements in color, black and white, etc. The display medium 232 can display, for example, images, pictures, paintings, text, advertising information, etc. The display medium 232 can have a size (e.g., height and width) that, in some examples, substantially matches a size of the display structure 230 and/or the surface portion 204. In other examples, the display medium 232 can have a size that is less than a size of the display structure 230 and/or the surface portion 204. Since the display structure 230 is substantially transparent, the display medium 232 (e.g., the textual and/or graphic elements of the display medium 232) can be visible through the display structure 230.

Referring to FIGS. 3 and 4, an example of the hygiene system 100 is illustrated. In this example, the surface portion 204 and the display structure 230 can have a substantially non-planar shape. For example, the surface portion 204, in particular the outer surface 234 of the surface portion 204, can have a rounded, curved, arcuate, etc. shape. The display structure 230 can also have a rounded, curved, arcuate, etc. shape. The display structure 230 and the surface portion 204 can therefore have a substantially matching shape. As such, when the display structure 230 is attached to the surface portion 204, the display structure 230 is substantially flush with and in close proximity to the surface portion 204.

In an example, the outer surface 234 of the surface portion 204 can define a recessed portion 300 that is configured to receive the display medium 232. The recessed portion 300 defines a space, depression, furrow, channel, or the like in the outer surface 234. In an example, the recessed portion 300 is bounded by one or more sidewalls 302 (e.g., upper sidewall, lower sidewall, and lateral sidewalls). In this example, the display structure 230 has a display size (e.g., height and width) that substantially matches a recess size (e.g., height and width) of the recessed portion 300. In this example, the display medium 232 has a display medium size (e.g., height and width) that substantially matches the recess size (e.g., height and width) of the recessed portion 300. In another example, the display structure 230 can have a display size (e.g., height and width) that substantially matches a mounting portion size (e.g., height and width) of the mounting portion 202.

The display structure 230 and the display medium 232 can therefore be received within the recessed portion 300. Due to the substantially matching sizes of the display structure 230 and the recessed portion 300, the display structure 230 and the sidewalls 302 of the recessed portion 300 can form a friction fit with outer edges of the display structure 230 in contact with the sidewalls 302 of the recessed portion 300. As such, the display structure 230 may be secured within the recessed portion 300 with a reduced likelihood of being inadvertently removed from the recessed portion 300. To further assist in attaching the display structure 230 with respect to the surface portion 204, one or more fasteners (e.g., screws, nuts, bolts, nails, etc.), adhesives, locking structures (e.g., clamps, brackets, clasps, etc.) or the like may be incorporated as part of the display structure 230 and/or the surface portion 204.

In an example, the hygiene system housing 102 has a housing height 310 (e.g., as illustrated in FIG. 2) and a housing width 312 (e.g., as illustrated in FIG. 4), as measured at the mounting portion 202 and/or the attachment portion 205 of the surface portion 204. The surface portion 204 has a surface height 314 (e.g., as illustrated in FIG. 2) and a surface width 316 (e.g., as illustrated in FIG. 4). In an example, the surface height 314 of the surface portion 204 is larger than the housing height 310 of the hygiene system housing 102. In another example, the surface width 316 of the surface portion 204 is larger than the housing width 312 of the hygiene system housing 102.

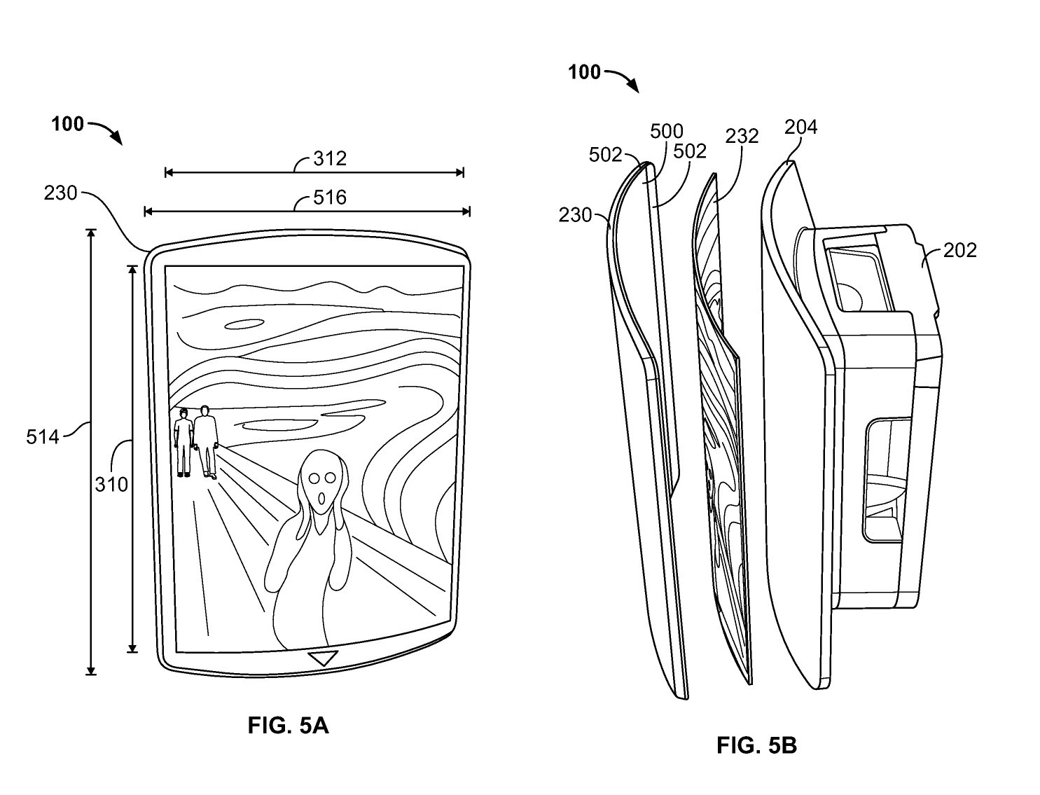

Turning to FIGS. 5A and 5B, in this example, the display structure 230 can have a larger size than the surface portion 204. In such an example, the display structure 230 can define a recessed portion 500 that is configured to receive the display medium 232 and a portion of (e.g., a front face of) the surface portion 204. The recessed portion 500 defines a space, depression, furrow, channel, or the like in the inner surface 236 of the display structure 230. In an example, the recessed portion 500 is bounded by one or more sidewalls 502. The display structure 230 has a display size (e.g., display height 514 and a display width 516) that is larger than a surface portion size of the surface portion 204. As such, the surface portion 204 can at least partially be received within the recessed portion 500 of the display structure 230. In this example, the display medium 232 has a display medium size (e.g., height and width) that is substantially equal to or less than a recessed size (e.g., height and width) of the recessed portion 500. As such, the display medium 232 can be received within the recessed portion 500, such that the display medium 232 is sandwiched by and supported between the outer surface 234 of the surface portion 204 and the inner surface 236 of the display structure 230.

In this example, the display height 514 of the display structure 230 is larger than the housing height 310 of the hygiene system housing 102. In this example, the display width 516 of the display structure 230 is larger than the housing width 312 of the hygiene system housing 102.

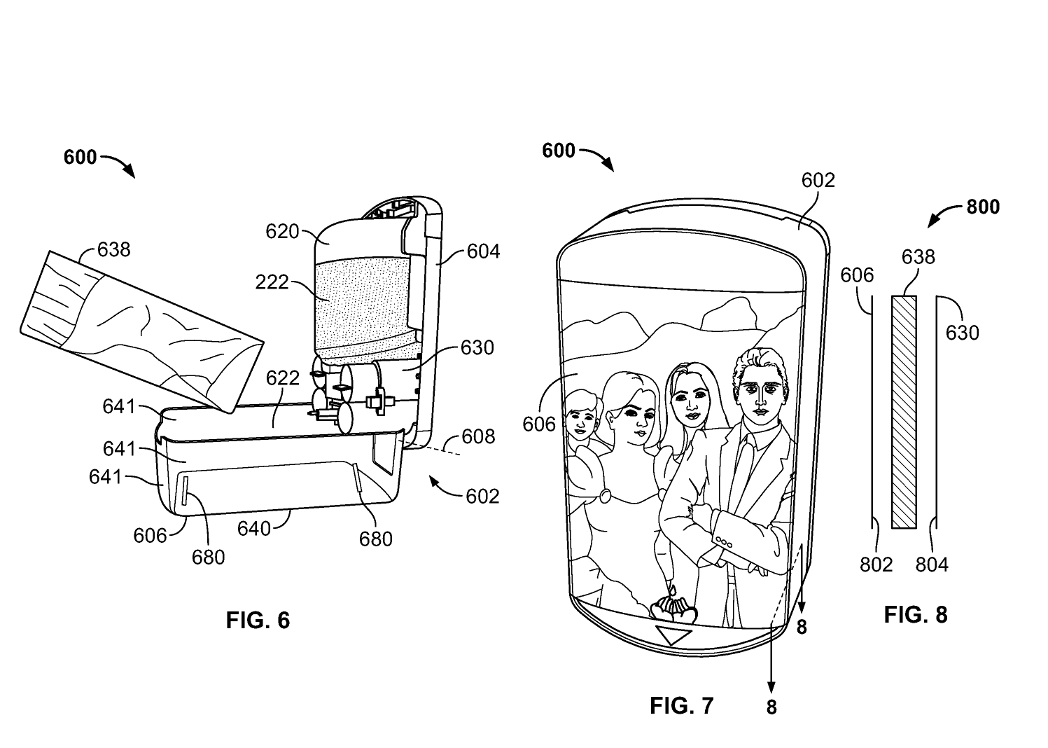

Turning to FIGS. 6 and 7, a second example hygiene system 600 is illustrated. The hygiene system 600 comprises a hygiene system housing 602. The hygiene system housing 602 comprises a mounting portion 604 and a display structure 606 that is attached to the mounting portion 604. In an example, the mounting portion 604 is configured to be mounted to a mounting surface.

The display structure 606 is moveably attached to the mounting portion 604. For example, the display structure 606 is moveable between an opened position (e.g., as illustrated in FIG. 6) and a closed position (e.g., as illustrated in FIG. 7). By being moveable, the display structure 606 can be pivotable with respect to the mounting portion 604 about a pivot axis 608. In a possible example, the mounting portion 604 and the display structure 606 can comprise an outwardly extending portion and an opening, with the outwardly extending portion positioned to extend through the opening. In such an example, the display structure 606 can pivot about the pivot axis 608 with respect to the mounting portion 604 between the opened position and the closed position.

The hygiene system 600 comprises a reservoir 620 that is similar in some respects to the reservoir 220. For example, the reservoir 620 comprises container, enclosure, vessel, pouch, etc. into which the hygiene product 222 can be received and from which the hygiene product 222 can be dispensed. The reservoir 620 can be supported within an interior 622 of the hygiene system housing 602 between the mounting portion 604 and the display structure 606.

The hygiene system 600 comprises a dispensing mechanism 630 for dispensing the hygiene product 222 from the reservoir 620. In some examples, the dispensing mechanism 630 is similar in some respects to the dispensing mechanism 224. For example, the dispensing mechanism 630 can be disposed within the interior 622 of the hygiene system housing 602 between the mounting portion 604 and the display structure 606. In this example, the dispensing mechanism 630 comprises one or more of a pump, an actuator, sensors, levers, or other types of devices that can assist in causing an expulsion of the hygiene product 222 from the reservoir 620.

FIG. 8 illustrates a sectional view of the hygiene system 600, in particular portions of the display structure 606 and the dispensing mechanism 630, as viewed from the perspective of lines 8-8. The display structure 606 defines a display space 800 between an inner surface 802 of the display structure 606 and an outer surface 804 of the dispensing mechanism 630. The display space 800 of the display structure 606 can be bounded by a plurality of walls, such as the front wall 640 and the sidewalls 641 of the display structure 606. The display space 800 defines a gap, space, opening, or the like between the display structure 606 on one side, and the dispensing mechanism 630 and/or the reservoir 620 on an opposing side. In some examples, the display space 800 has a width (e.g., distance between the display structure 606 and the dispensing mechanism 630 and/or the reservoir 620) that is less than about 12 millimeters.

Referring to FIGS. 6 to 8, the display structure 606 can support a display medium 638 disposed within the display space 800. For example, the display medium 638 can be disposed within the display space 800 between the inner surface 802 of the display structure 606 and the outer surface 804 of the dispensing mechanism 630 (and/or the reservoir 620). As such, the display medium 638 is substantially limited from being inadvertently removed from the display space 800 when the display structure 606 is in the closed position (e.g., as illustrated in FIGS. 7 and 8).

In an example, when the display medium 638 is disposed within the display space 800, a front side of the display medium 638 is in proximity to and/or in contact with the front wall 640 and/or the sidewalls 641 of the display structure 606. A rear side of the display medium 638 is in proximity to and/or in contact with the dispensing mechanism 630 and the reservoir 620. In this example, the display medium 638 is substantially limited from being inadvertently removed from the display space 800 due to the relatively close proximity to the display structure 606 and the dispensing mechanism 630 and the reservoir 620.

In some examples, the display structure 606 can comprise one or more holding mechanisms 680 (e.g., illustrated in FIG. 6). The holding mechanisms 680 can be provided on the inner surface 802 of the display structure 606. In this example, the one or more holding mechanisms 680 can project from the inner surface 802 of the front wall 640 and/or the sidewalls 641 towards the dispensing mechanism 630. The holding mechanisms 680 can comprise, for example, protrusions, outcroppings, ridges, or the like. In an example, the display medium 638 can be supported on and/or between the holding mechanisms 680, such that the holding mechanisms 680 can secure the display medium 638 within the display space 800 while limiting movement (e.g., up and down) of the display medium 638 with respect to the display structure 606.

The display medium 638 is similar in some respects to the display medium 232. For example, the display medium 638 can display textual and/or graphic elements in color, black and white, etc. The display medium 638 can display, for example, images, pictures, paintings, text, advertising information, etc. The display medium 232 can have a size (e.g., height and width) that, in some examples, substantially matches a size of the display structure 606.

The display structure 606 is substantially transparent such that the display medium 638 is visible through the display structure 606. In this example, the front walls 640 and/or the sidewalls 641 of the display structure 606 are substantially transparent. The display structure 230 can comprise a number of different transparent structures, such as plastic, glass, or the like. Since the display structure 606 is substantially transparent, the display medium 638 (e.g., the textual and/or graphic elements of the display medium 638) can be visible through the display structure 606.

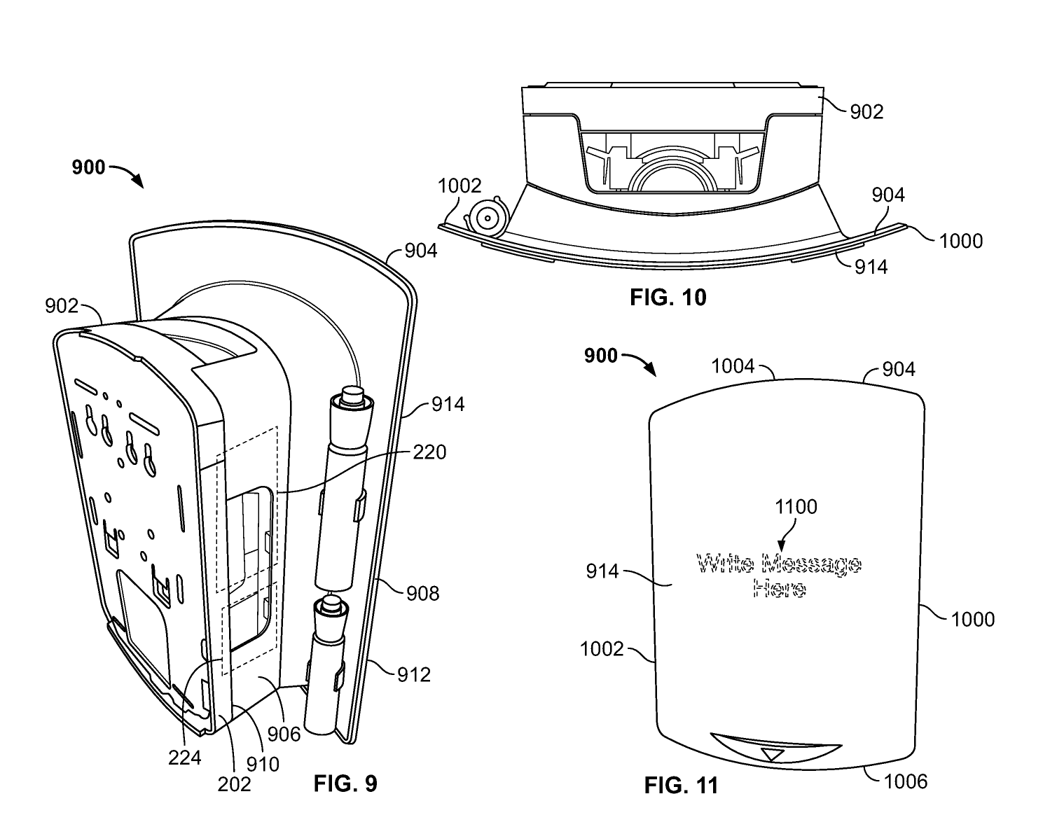

Turning to FIGS. 9 to 11, a third example hygiene system 900 is illustrated. The hygiene system 900 comprises a hygiene system housing 902 comprising the mounting portion 202 and a display structure 904 that is attached to the mounting portion 202. In this example, the mounting portion 202 can be mounted to a mounting surface.

The display structure 904 is substantially similar to the surface portion 204 of the hygiene system housing 102. For example, the display structure 904 can be removably attached to the mounting portion 202. In an example, one or more mechanical fasteners can be provided as part of the mounting portion 202 and/or the display structure 904 so as to attach the mounting portion 202 and the display structure 904. In some examples, these mechanical fasteners may comprise locking structures (e.g., snap fit structures), screws, bolts, nuts, etc.

The mounting portion 202 and the display structure 904 can together define the interior of the hygiene system housing 902. The reservoir 220 can be supported within the interior 200 of the hygiene system housing 902, such as between the mounting portion 202 and the display structure 904. The dispensing mechanism 224 can also be disposed within the interior 200 between the mounting portion 202 and the hygiene system housing 902.

In an example, the display structure 904 comprises an attachment portion 906 and a surface portion 908. The display structure 904 has a first side 910 and a second side 912, with the attachment portion 906 located on the first side 910 of the display structure 904 and the surface portion 908 located on the second side 912 of the display structure 904. In this example, the first side 910 of the display structure 904 (e.g., corresponding to the attachment portion 906) is attached to the mounting portion 202 while the second side 912 of the display structure 904 (e.g., corresponding to the surface portion 908) comprises a writing surface 914.

Turning now to FIG. 10, a top-down view of the hygiene system 900 is illustrated. In this example, the writing surface 914 has a substantially non-planar shape. By being substantially non-planar, the writing surface 914 may not lie in a single plane. In the illustrated example, the writing surface 914 has a rounded, curved, arcuate shape between a first lateral side 1000 and a second lateral side 1002. The writing surface 914 can extend substantially linearly between an upper side 1004 and a lower side 1006. It will be appreciated that the writing surface 914 is not limited to the illustrated shape of FIG. 10. Rather, in other examples, the writing surface 914 can have a larger or smaller degree of bending and/or curvature between the first lateral side 1000 and the second lateral side 1002. In some examples, the writing surface 914 need not be substantially non-planar and, instead, may comprise a substantially planar writing surface 914 (e.g., by being substantially flat).

Turning now to FIG. 11, the writing surface 914 of the hygiene system 900 is illustrated. In an example, the writing surface 914 of the display structure 904 comprises at least one of a dry-erase board or a chalkboard. In this example, the at least one of the dry-erase board or the chalkboard comprises a substantially non-absorbent writing surface. The dry-erase board may also be referred to as a marker-board, a white-board, a dry-wipe board, a pen-board, etc. In a possible example, the dry-erase board comprises a laminated board having a polyester and/or an acrylic coating. In some examples, the dry-erase board comprises a melamine material (e.g., a resin-infused paper), a painted steel or aluminum material, a hardcoat laminate material, and/or a porcelain, enamel-on-steel material. In these examples, a non-permanent pen or marker can have an erasable ink that adheres to the writing surface 914 without binding to or being absorbed by the writing surface 914. As such, the non-permanent pen or marker can make one or more markings 1100 on the writing surface 914, with the one or more markings 1100 being capable of being erased. In an example, the writing surface 914 of the hygiene system 900 comprises a magnet, such as a material or object that produces a magnetic field. In such an example, one or more magnetic materials can be magnetically adhered to the writing surface 914.

The hygiene system 100, 600, 900 in the illustrated examples provides a benefit of displaying information via the display medium and/or the writing surface. For example, the hygiene system 100, 600, 900 can display marketing information, announcement information, schedules, reminders, or the like. As such, the hygiene system 100, 600, 900 can simultaneously provide a hygiene product to a user while also displaying the aforementioned information via the display medium and/or the writing surface.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first component and a second component correspond to component A and component B or two different or two identical components or the same component.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are to be construed to mean “one or more” unless specified otherwise or clear from context to be directed to a singular form. Also, at least one of A and B or the like means A or B or both A and B. Furthermore, to the extent that “includes”, “having”, “has”, “with”, or variants thereof are used in either the detailed description or the claims, such terms are intended to be inclusive in a manner similar to “comprising”.

Also, although the disclosure has been illustrated and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A hygiene system for dispensing a hygiene product, the hygiene system comprising:
a hygiene system housing comprising a mounting portion and a surface portion attached to the mounting portion, the mounting portion configured to be mounted to a mounting surface;
a dispensing mechanism disposed within an interior of the hygiene system housing between the mounting portion and the surface portion and configured to dispense the hygiene product; and
a display structure attached to the surface portion and configured to support a display medium disposed between an outer surface of the surface portion and an inner surface of the display structure, the display structure being substantially transparent such that the display medium is visible through the display structure.

2. The hygiene system of claim 1, wherein the surface portion defines a recessed portion configured to receive the display medium.

3. The hygiene system of claim 2, wherein the display structure has a display size that substantially matches a recess size of the recessed portion.

4. The hygiene system of claim 1, wherein the display structure has a display size that substantially matches a mounting portion size of the mounting portion.

5. The hygiene system of claim 1, wherein the display structure has a substantially non-planar shape.

6. The hygiene system of claim 1, wherein the hygiene system housing has a housing height and a housing width, the display structure having a display height and a display width.

7. The hygiene system of claim 6, wherein the display height of the display structure is larger than the housing height of the hygiene system housing.

8. The hygiene system of claim 6, wherein the display width of the display structure is larger than the housing width of the hygiene system housing.

9. The hygiene system of claim 1, wherein the surface portion is removably attached to the mounting portion.

10. The hygiene system of claim 1, comprising a reservoir, within which the hygiene product is contained and from which the hygiene product is dispensed, disposed within the interior of the hygiene system housing between the mounting portion and the surface portion.

11. The hygiene system of claim 10, wherein the dispensing mechanism is operatively coupled to the reservoir, the dispensing mechanism configured to actuate a dispense event such that the hygiene product is dispensed from the reservoir.

12. A hygiene system for dispensing a hygiene product, the hygiene system comprising:
a hygiene system housing comprising a mounting portion and a display structure, the mounting portion configured to be mounted to a mounting surface; and
a dispensing mechanism disposed within an interior of the hygiene system housing between the mounting portion and the display structure and configured to dispense the hygiene product,
the display structure moveably attached to the mounting portion, the display structure moveable between an opened position in which the dispensing mechanism is exposed, and a closed position in which the dispensing mechanism is not exposed, the display structure defining a display space between an inner surface of the display structure and an outer surface of the dispensing mechanism when in the closed position, the display structure configured to support a display medium disposed within the display space, the display structure being substantially transparent such that the display medium is visible through the display structure.

13. The hygiene system of claim 12, comprising a holding mechanism on the inner surface of display structure, the holding mechanism configured to secure the display medium in the display space.

14. The hygiene system of claim 12, wherein the display structure is pivotable with respect to the mounting portion about a pivot axis.

15. The hygiene system of claim 12, wherein the display space of the display structure is bounded by a plurality of walls.

16. The hygiene system of claim 15, wherein the plurality of walls project from a front wall of the display structure towards the mounting portion.

17. A hygiene system for dispensing a hygiene product, the hygiene system comprising:
a hygiene system housing comprising a mounting portion and a display structure attached to the mounting portion, the mounting portion configured to be mounted to a mounting surface; and
a dispensing mechanism disposed within an interior of the hygiene system housing between the mounting portion and the display structure and configured to dispense the hygiene product,
the display structure comprising at least one of a dry-erase board or a chalkboard.

18. The hygiene system of claim 17, wherein the at least one of the dry-erase board or the chalkboard comprises a substantially non-absorbent writing surface.

19. The hygiene system of claim 18, wherein the writing surface has a substantially non-planar shape.

20. The hygiene system of claim 18, wherein the display structure has a first side and a second side, the first side of the display structure attached to the mounting portion, the second side of the display structure comprising the writing surface.
